(19) United States
(12) Patent Application Publication
(10) Pub. No.: US 2003/0044510 A1
(43) Pub. Date: Mar. 6, 2003

(54) Meat patty and process for production thereof

(76) Inventor: Arno U. Pfeiffer, Magdeburg (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/231,360

(22) Filed: Aug. 30, 2002

(30) Foreign Application Priority Data
Sep. 1, 2001 (DE) 101 42 985.1

(51) Int. Cl. A23L 1/31

(52) U.S. Cl. 426/646

(57) ABSTRACT

The invention relates to a process for producing patties of minced meat, comminuted bread or comminuted rolls, eggs and chopped onions which are mixed to form a mixture and shaped to form a patty. It is an object of the invention to provide a process and a meat patty which differs in appearance and taste from the conventional meat patties and in addition has an improved shelf life. The object is achieved by the meat being cured pork.

The invention relates to a process for producing patties according to the preamble of claim 1 and to a meat patty as such and a use of the patty according to claim 17.

The prior art discloses meat patties made of minced pork or beef which are mixed with other ingredients to form what are called pellets and are used as frozen raw materials for preparing hamburgers or the like. The pan-fried shaped meat pieces are generally placed between two bread roll halves and there provided with diverse sauces and accompaniments and sold.

It is an object of the present invention to provide a process and a meat patty which differs in appearance and taste from the conventional meat patties and in addition has an improved shelf life.

According to the invention this is achieved by a process having the features of claim 1 and by a meat patty produced according to such a process.

The use of cured pork, in addition to a taste change of the meat patty, causes a shortening of the cooking time, since the cured pork has been appropriately prepared by the preceding treatment process so that only a short cooking time need be provided in order to prepare the patty so that it is ready to serve and ready for consumption. In addition, the preceding curing of the meat produces improved shelf life of the patty.

A development of the process provides that a defined amount of Kassler pork chop or Kassler pork neck is comminuted using a meat grinder. One-eighth to one-twelfth of the weight of meat of bread or rolls is comminuted, the bread or rolls being softened in advance, in particular in water, and squeezed out. Advantageously, one-tenth of the weight of meat of bread or rolls is comminuted, in particular white bread being provided as bread ingredient.

In addition, one-eighth to one-twelfth of the weight of meat of bacon or smoked ham is finely minced and browned, here also, advantageously, one-tenth of the weight of meat of bacon or smoked ham being used. Onions, in the same amount as bread or smoked ham are finely chopped and one-fifth to one-eighth the weight of meat of eggs are beaten. All the ingredients are placed in a vessel and stirred to form a smooth mixture which is then portioned. This is performed by taking out a subquantity from the total mixture and shaping it to form an essentially flat cylindrical patty. The flat cylindrical shape of the patty has the advantage that a very high surface area is created, as a result of which, on turning once in the subsequent preparation, rapid heating is ensured, which distinguishes the patty in particular as a component of a fast dish.

Advantageously, spices, in particular pepper, salt and caraway, are added to the mixture before shaping.

In a development it is provided that the patties are halved orthogonally to the cylinder axis and that at least one cheese slice is placed between these patty halves. The filling beneficially affects the taste and increases the content of milk protein in the patty, which leads to a more balanced diet.

Advantageously, the cheese filling or the cheese slice is dimensioned such that the patty halves, after they have been placed one above the other, completely enclose the cheese filling. Enclosing the cheese filling by the meat patty prevents the melting cheese from running out during preparation, whether it be by pan-frying or in a microwave. It is provided here that to enclose the cheese filling, the rims of the patty halves, after they have been placed one above the other, are pressed together, as a result of which the homogeneous state of the patty is virtually restored in the rim region outside the cheese filling.

Advantageously, the bacon or smoked ham is heated to melt out fat and browned until a solid consistency is achieved, which is observed by a color change toward brown. By melting out the fat from the bacon or smoked ham, the total fat content of the patty is reduced and an additional seasoning is performed. This also increases the crispiness of the overall patty.

To provide a uniform outer casing during the subsequent preparation of the patty and to ensure dimensional stability during pan-frying or heating in a microwave, it is provided that the patty is rolled on all sides in a breadcrumb coating.

Since the patty is generally consumed in combination with accompaniments, it is provided that the subquantity taken out from the total mixture has a weight of 100 to 200 grams. This means that the patty has a portion size which is considered by the overwhelming majority of the population as a sufficient meat portion for a snack or complete meal.

In order for it not to be necessary to consume the patty immediately after preparation, it is advantageous that it is vacuum-packed or packaged frozen in order to facilitate transport and to enable or facilitate distribution of industrially manufactured patties.

A development provides that the patty is pan-fried in hot, in particular boiling, fat, in which case the fat used for preparation can be the fat which is produced during melting out of the fat from the bacon or smoked ham. The pan-fried patty, after cooling, can also be vacuum-packed or frozen, in order to facilitate or enable distribution and storage.

Furthermore, it is provided that after the patty is disposed between two bread roll halves, it is then vacuum-packed or packaged frozen, which produces and prepares a complete ready meal, which merely needs to be thawed or removed from the packaging and heated, for example by an oven, grill or microwave oven. In this manner a complete ready meal which can be prepared rapidly is provided.

Depending on flavor, ketchup, mayonnaise, mustard or roast onions can be added to the patty before packaging, in various combinations or singly.

A development of the meat patty thus produced provides that the patty is disposed between two bread roll halves which advantageously are made as potato rolls and that sauerkraut, coleslaw or green beans are assigned to the meat patty as garnish.

A further advantage of the above-described meat patty is that a meal usually offered as a plate dish is brought into a compact form, as a result of which this is readily transportable and can also be eaten on the move. This is in particular the case when the meat patty is already pan-fried and packaged disposed between two bread roll halves, the storage between two bread roll halves enabling eating and handling the patty without dirtying the hands.

The white bread or the rolls are first softened in water and the white bread/roll-water mixture produced in such a manner is squeezed so that a solid mixture is formed which has a certain degree of residual moisture in order to ensure homogeneous consistency of the mixture. The homogeneity of the mixture is increased by adding beaten eggs.

To prepare the meat patty, Kassler pork neck is finely ground in a meat grinder or a similar instrument, and mixed with finely chopped onions, beaten eggs, caraway powder and pepper and squeezed and comminuted white bread or rolls. The pan-fried, browned bacon or smoked ham from which the fat has been melted out is mixed with the resultant mixture and processed to form a smooth essentially homogeneous dough. By means of a separating apparatus, the portioned meat patties which have been brought into an essentially flat cylindrical shape are halved and coated with a cheese slice which is matched in size to the diameter of the meat patty. This thus provides that the cheese slice at no point projects beyond the periphery of the meat patty. The halves are then placed one on top of the other and pushed together again, so that essentially the previously generated flat-cylindrical form is restored. The cut surfaces are tightly closed in the rim region in order to prevent the cheese from running out during the subsequent heating or pan-frying.

The portioned patties are alternatively first breadcrumb-coated and then pan-fried on a low flame, for example, in the melted-out smoked ham fat.

Alternatively, the patty can, in a separate fat, be pan-fried, deep-fried in oil or baked in an oven or grill.

After the pan-frying or heating, the meat patty is placed into cut-open bread roll halves, preferably potato rolls, and dressed with sauerkraut or a corresponding coleslaw. Alternatively thereto, green beans are provided. Roast onions, ketchup, mustard or mayonnaise can be added as required to the patty.

Approximately 10 portions require 1 500 grams of cured pork, 150 grams of white bread or rolls, 150 grams of bacon or smoked ham, 150 grams of sliced cheese, for example Emmental, 3 eggs, 1.5 teaspoons of caraway powder and 10 potato rolls. Pepper and salt can be added as required.

1. A process for producing patties from minced meat, comminuted bread or comminuted rolls, eggs and chopped onions which are mixed to form a mixture and shaped to form a patty, which comprises the meat being cured pork.

2. The process as claimed in claim 1, wherein a predetermined amount of Kassler pork chop or Kassler pork neck is comminuted using a meat grinder, one-eighth to one-twelfth of the weight of meat of bread or rolls is comminuted, the bread or the rolls being softened in advance and squeezed out, one-eighth to one-twelfth of the weight of meat of bacon or smoked ham is finely minced and browned, one-eighth to one-twelfth of the weight of meat of onions are finely chopped, one-fifth to one-eighth of the weight of meat of eggs are beaten, the ingredients are placed in a vessel and stirred to form a smooth mixture, a subquantity is taken out from the mixture and shaped to form an essentially flat cylindrical patty.

3. The process as claimed in claim 1 or 2, wherein spices, in particular pepper, salt and caraway, are added to the mixture.

4. The process as claimed in one of the preceding claims, wherein the patties are halved orthogonally to the cylinder axis, at least one cheese slice is placed between the halves.

5. The process as claimed in claim 4, wherein the cheese filling is dimensioned such that the patty halves, after they have been placed one above the other, enclose the cheese filling.

6. The process as claimed in claim 5, wherein to enclose the cheese filling, the rims of the patty halves are pressed together.

7. The process as claimed in one of the preceding claims, wherein the bacon or smoked ham is pan-fried brown.

8. The process as claimed in one of the preceding claims, wherein the patty is rolled in a breadcrumb coating.

9. The process as claimed in one of the preceding claims, wherein the subquantity has a weight of 100 g to 200 g.

10. The process as claimed in one of the preceding claims, wherein the patty is vacuum-packed or packaged frozen.

11. The process as claimed in one of claims 1 to 9, wherein the patty is pan-fried in hot, in particular boiling, fat.

12. The process as claimed in claim 11, wherein the patty is cooled after pan-frying and vacuum-packed or packaged frozen.

13. The process as claimed in claim 11, wherein, after the pan-frying, the patty is disposed between two bread roll halves and is then vacuum-packed or packaged frozen.

14. The process as claimed in claim 13, wherein roast onions and/or ketchup and/or mayonnaise and/or mustard is added to the patty.

15. A meat patty produced by one of the preceding claims.

16. The meat patty as claimed in claim 15, wherein the patty is disposed between two bread roll halves.

17. The use of the patty as claimed in one of the preceding claims as a ready meal.
